(19) United States
(12) Patent Application Publication
(10) Pub. No.: US 2008/0084366 A1
(43) Pub. Date: Apr. 10, 2008

(54) Display device

(75) Inventors: Teruaki Saito, Mobara (JP); Hideo Sato, Hitachi (JP); Shigeyuki Nishitani, Mobara (JP)

Correspondence Address: Stanley P. Fisher;Reed Smith LLP, 3110 Fairview Park Drive, Suite 1400, Falls Church, VA, 22042-4503, US

(73) Assignee: Hitachi Displays, Ltd.

(21) Appl. No.: 11/905,070

(22) Filed: Sep. 27, 2007

(30) Foreign Application Priority Data
Oct. 6, 2006 (JP) 2006-275484

(51) Int. Cl. G09G 3/20; G09G 3/36

(52) U.S. Cl. 345/76; 345/55; 345/92

(57) ABSTRACT

A photosensor for selecting a specific function is arranged around an effective screen. A window is formed in a portion of a display substrate corresponding to the photosensor. When a user touches the window with his/her finger, an external light is interrupted and a signal is generated, and the signal is used as a signal for selecting the specific function. The photosensor and peripheral circuits are formed using a process substantially equal to, a process for forming a TFT of a pixel portion and hence, the increase of a cost can be suppressed.

The present application claims priority from Japanese applications JP2006-275484 filed on Oct. 6, 2006, the content of which is hereby incorporated by reference into this application.

### BACKGROUND OF THE INVENTION

1. Field of the Invention

The present invention relates to a display device and, more particularly to a device which arranges a photosensor on a substrate outside an effective screen and includes a means for selecting a display function using the photosensor.

2. Description of the Related Art

A planar display such as a liquid crystal display device has been popularly used for a mobile phone or the like. Particularly, the mobile phone is increasing the number of functions thereof in recent years and hence, in performing a certain manipulation, depending on the function, it is necessary for a user to perform many selections before the user arrives at a desired function from a menu selection screen. When the user is not accustomed to the manipulation of such setting, it is difficult for the user to properly perform such selection and hence, the user cannot make use of the valuable function.

On the other hand, there also has been known an invention which assembles a sensor element in a liquid crystal display panel which particularly mounts thin film transistors (TFT) thereon, wherein the sensor element is used as an input means. A patent document 1 (JP-A-7-261932) discloses such an invention.

### SUMMARY OF THE INVENTION

When a screen of a display device is large, with respect to specific functions which are frequently used by the user, the user can take out the necessary function by arranging icons on upper and lower portions of the screen or the like, for example. However, the mobile phone or the like has a small screen and hence, the arrangement of a large number of icons on the screen is difficult. Further, the mobile phone is not configured to allow the user to carry a mouse with the mobile phone. Still further, an addition of a function of moving a pointer by sliding the pointer with a finger in place of a mouse requires a space on a screen of a display device. Accordingly, this technique is not realistic so long as the mobile phone or the like is concerned.

A technique described in the patent document 1 uses a liquid crystal display panel as a main input means of an information processing device. That is, the patent document 1 describes the technique which realizes both of inputting of information with a finger and inputting of information with a pen. However, it is difficult to apply such an inputting method to a display device having a small screen size such as a mobile phone. Further, it is cumbersome for a user to always carry an inputting pen with him or her.

Accordingly, it is an object of the present invention to provide a display device which arranges a photosensor on a substrate outside an effective screen thereof and allows a user to select a specific function by touching a substrate (usually made of glass) corresponding to the photosensor. That is, the user can select a necessary function by using the photosensor as a touch sensor. By arranging a plurality of photosensors on the substrate outside the effective screen, the user can select a plurality of functions. To explain specific means of the display device, they are as follows.

(1) The present invention is directed to a display device which includes a substrate on which pixels are mounted in a matrix array within an effective screen thereof, and in which an image signal applied to each pixel is controlled by a thin film transistor which corresponds to each pixel, wherein a photosensor is arranged on the substrate outside the effective screen, the photosensor generates a signal by interrupting an external light, and the signal from the photosensor allows the display device to perform a specific function.

(2) A display device according to means (1), wherein a light blocking layer which interrupts the external light is formed on the substrate outside the effective screen, and the light blocking layer is not formed on a portion of the substrate which corresponds to the photosensor.

(3) A display device according to means (1), wherein the photosensor is constituted of a sensor-use thin film transistor which is formed by steps equal to the steps for forming the thin film transistor which corresponds to each pixel.

(4) A display device according to means (3), wherein a gate of the sensor-use thin film transistor adopts the diode constitution in which the gate is connected to a drain or a source of the sensor-use thin film transistor.

(5) A display device according to means (1), wherein the signal from the photosensor is transmitted to a signal processing circuit via a circuit which is mounted on the same substrate on which the thin film transistor corresponding to each pixel is formed and transfers the signal.

(6) A display device according to means (5), wherein the circuit which transfers the signal includes a parallel/serial conversion circuit.

(7) A display device according to means (5), wherein the circuit which transfers a signal is formed on a side closer to the effective screen side than the photosensor.

(8) A display device according to means (3), wherein the thin film transistor corresponding to each pixel is made of polysilicon.

(9) A display device according to means (1), wherein a light blocking layer is formed on a portion of a back side of the substrate on which the photosensor is formed in a state that the portion corresponds to a portion of the substrate where the photosensor is arranged.

(10) A display device according to means (1), wherein a plurality of photosensors is formed on the substrate outside the effective screen, and signals form the plurality of photosensors allow the display device to perform the same function.

(11) A display device according to means (1), wherein a light blocking layer for interrupting an external light is formed on the substrate outside the effective screen, a window portion in which the light blocking layer is not formed is formed on a portion of the substrate which corresponds to the photosensor, and a plurality of photosensors is formed in the portion of the substrate which corresponds to the window portion.

(12) The present invention is directed to a liquid crystal display device including a liquid crystal display panel which includes a TFT substrate on which pixel electrodes and thin film transistors each of which controls a signal voltage applied to the pixel electrodes are formed within an effective screen thereof, a color filter substrate on which color filters and a black matrix are formed within an effective screen thereof, and liquid crystal which is sandwiched by the TFT substrate and the color filter substrate, and forms an image, and a backlight, wherein the photosensor is formed outside the effective screen of the TFT substrate, the photosensor generates a signal by interrupting an external light, and the signal from the photosensor allows the display device to perform a specific function.

(13) A liquid crystal display device according to means (12), wherein a light blocking film which interrupts the external light is formed outside the effective screen of the color filter substrate, and the light blocking layer is not formed on a portion of the color filter substrate which corresponds to the photosensor.

(14) A liquid crystal display device according to means (12), wherein the light blocking film is made of the same material as the black matrix.

(15) A liquid crystal display device according to means (12), wherein the photosensor is constituted of a sensor-use thin film transistor which is formed by steps equal to steps for forming the thin film transistor which controls the signal voltage applied to the pixel electrodes.

(16) A liquid crystal display device according to means (12), wherein a gate of the sensor-use thin film transistor adopts the diode constitution in which the gate is connected to a drain or a source of the sensor-use thin film transistor.

(17) A liquid crystal display device according to means (12), wherein a light blocking layer is formed between the TFT substrate on which the photosensor is formed and the backlight.

(18) The present invention is directed to an organic EL display device which includes a substrate on which organic EL layers which constitute pixels are formed in a matrix array within an effective screen, and forms an image by applying a signal voltage to the organic EL layers, wherein the signal voltage applied to the organic EL layer is controlled by a thin film transistor, a photosensor is arranged on the substrate outside the effective screen, the photosensor generates a signal by interrupting an external light, and the signal from the photosensor allows the display deice to perform a specific function.

(19) An organic EL display device according to means (18), wherein the photosensor includes a sensor-use thin film transistor which is formed by steps equal to the steps for forming the thin film transistor which controls the signal voltage applied to the organic EL layer.

(20) An organic EL display device according to means (18), wherein the organic EL display device is of a bottom emission type.

According to the present invention, a user can select a specific function by touching the substrate corresponding to the specific photosensor arranged outside the effective screen of the display device and hence, the user can easily manipulate the display device. Accordingly, the present invention has an advantageous effect that even a user who is not accustomed to the manipulation of a mobile phone or the like can use a necessary function of the mobile phone or the like. To explain advantageous effects which the respective means acquire, they are as follows.

According to the means (1), by arranging the sensor for displaying the specific function outside the effective screen of the display device, a user can easily select the specific function.

According to the means (2), portions except for the portion of the substrate on which the photosensor is formed are covered with the light blocking layer and hence, it is possible to increase a light blocking effect when a user touches the portion of the substrate corresponding to the photosensor.

According to the means (3), the photosensor-use thin film transistor can be formed by steps equal to the steps for forming the thin film transistor which is arranged in each pixel portion and hence, it is possible to suppress the increase of a cost for forming a photo diode.

According to the means (4), the thin film transistor can be used as the photo diode and hence, the increase of a cost for forming the photosensor can be suppressed.

According to the means (5) and the means (6), the circuit which transfers an output signal from the photodiode can be formed by steps equal to the steps for forming the pixel TFT and hence, the increase of a cost attributed to a provision of the circuit which transfers the output signal can be suppressed.

According to the means (7), the photosensor is mounted on the portion of the substrate remoter from the effective screen than the circuit which transfers the signal and hence, it is possible to reduce the influence of light from the screen on the photosensor thus increasing the sensitivity of the photosensor.

According to the means (8), the thin film transistor arranged in each pixel and the photo transistor portion are made of polysilicon and hence, it is possible to constitute a system which exhibits a high processing speed and high reliability.

According to the means (9), the light blocking layer is formed on the back side of the photosensor and hence, it is possible to suppress the influence of light from the back side of the photosensor such as light of the backlight or an external light on the photosensor.

According to the means (10) and the means (11), the display device receives a signal for selecting one function from the plurality of photosensors and hence, the sensitivity of the display device can be increased as a whole thus enhancing the reliability of the system.

According to the means (12), in the liquid crystal display device which is popularly used at present, by mounting the sensor for displaying a specific function outside the effective screen of the display device, it is possible to easily select the specific function thus increasing practical effects.

According to the means (13), the light blocking film is formed on the color filter substrate and hence, it is possible to form the light blocking film with high accuracy.

According to the means (14), the photosensor-use light blocking film is formed simultaneously with the black matrix which is formed on the color filter substrate and hence, it is possible to form the light blocking film with high accuracy and an excellent light blocking effect without increasing a cost.

According to the means (15), the sensor-use thin film transistor is formed by steps equal to the steps for forming the thin film transistor which is formed in each pixel portion and hence, it is possible to realize the liquid crystal display device having the photosensor without substantially increasing a cost.

According to the means (16), the thin film transistor is used as the photo diode and hence, it is possible to realize the liquid crystal display device having the photosensor without increasing a cost.

According to the means (17), the light blocking film is arranged between the photosensor and the backlight and hence, it is possible to reduce an influence of the backlight on the signal of the photosensor.

According to the means (18), in the organic EL display device which has been recently used in the mobile phone or the like, by mounting the sensor for displaying the specific function outside the effective screen of the display device, a user can easily select the specific function and hence, a practical effect is large.

According to the means (19), as the photosensor, the thin film transistor which is formed by steps equal to the steps for forming the thin film transistor used in each pixel portion is used and hence, it is possible to form the photosensor without increasing a cost.

According to the means (20), the organic EL display device is of the bottom emission type and hence, when the thin film transistor which is formed by steps equal to the steps for forming the thin film transistor formed in each pixel portion is used as the photosensor, it is possible to form the photo transistor having excellent sensitivity with respect to an external light.

### BRIEF DESCRIPTION OF THE DRAWING

FIG. 1 is a schematic plan view of a display device of the present invention;

FIG. 2 is a perspective view of a display device of an embodiment 1;

FIG. 3 is a cross-sectional view of the display device of the embodiment 1;

FIG. 4 is a plan view of the display device of the embodiment 1;

FIG. 5 is a view showing an example of a sensor window portion;

FIG. 6 is a back view of the display device of the embodiment 1;

FIG. 7 is a cross-sectional of the display device of the embodiment 1 for explaining the manner of operation of the display device;

FIG. 8 is a cross-sectional view of a TFT arranged in a pixel portion;

FIG. 9 is a view for explaining a TFT portion in detail;

FIG. 10 is a view showing an equivalent circuit of a photosensor part;

FIG. 11 is an operational timing chart of the photosensor part;

FIG. 12 is a constitutional view of a photosensor circuit while including a circuit around the photosensor circuit;

FIG. 13 is an operational timing chart of the photosensor circuit and the peripheral circuit shown in FIG. 12;

FIG. 14 is a view showing an equivalent circuit of a photosensor of an embodiment 2;

FIG. 15 is a schematic view of a display device of an embodiment 3;

FIG. 16 is a view showing an equivalent circuit of a photosensor of the embodiment 3;

FIG. 17 is a schematic view of a display device of an embodiment 4; and

FIG. 18 is a cross-sectional view of an organic EL display deice.

### DESCRIPTION OF THE PREFERRED EMBODIMENTS

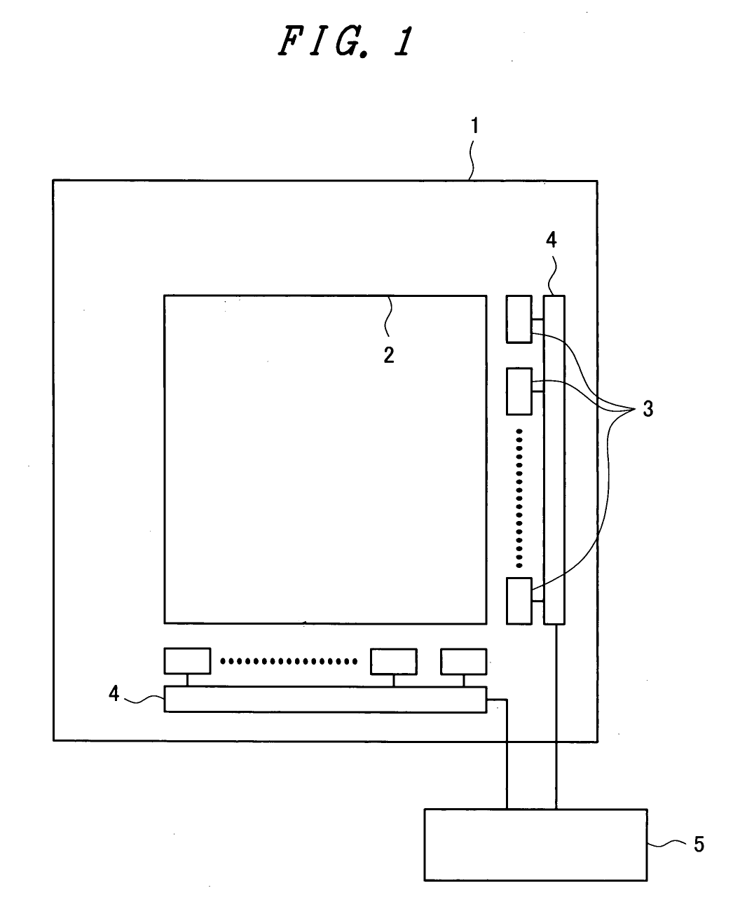

FIG. 1 is a conceptual view showing the schematic constitution of a display device of the present invention. In the present invention, a display device 1 is not limited to a specific type of display device and may be any display device including a liquid crystal display device and an organic EL display device. An effective screen 2 which displays an image is arranged in the inside of a display panel, and photosensors 3 are arranged outside the effective screen 2.

In FIG. 1, the plurality of photosensors 3 is arranged in the longitudinal direction as well as in the lateral direction of the effective screen. The photosensor 3 functions as a so-called touch sensor which changes an output thereof in response to contacting of a user's finger with the photosensor 3 and detects an output signal. Further, functions of an information processing device correspond to the respective photosensors 3. That is, the user can select a necessary function by touching the photosensor 3 corresponding to the function.

The output from the photosensor 3 is transmitted to a signal processing part 5 via a parallel/serial (P/S) conversion circuit 4, and the signal processing part 5 determines which function is selected. Then, the selected function is displayed on the effective screen.

### Embodiment 1

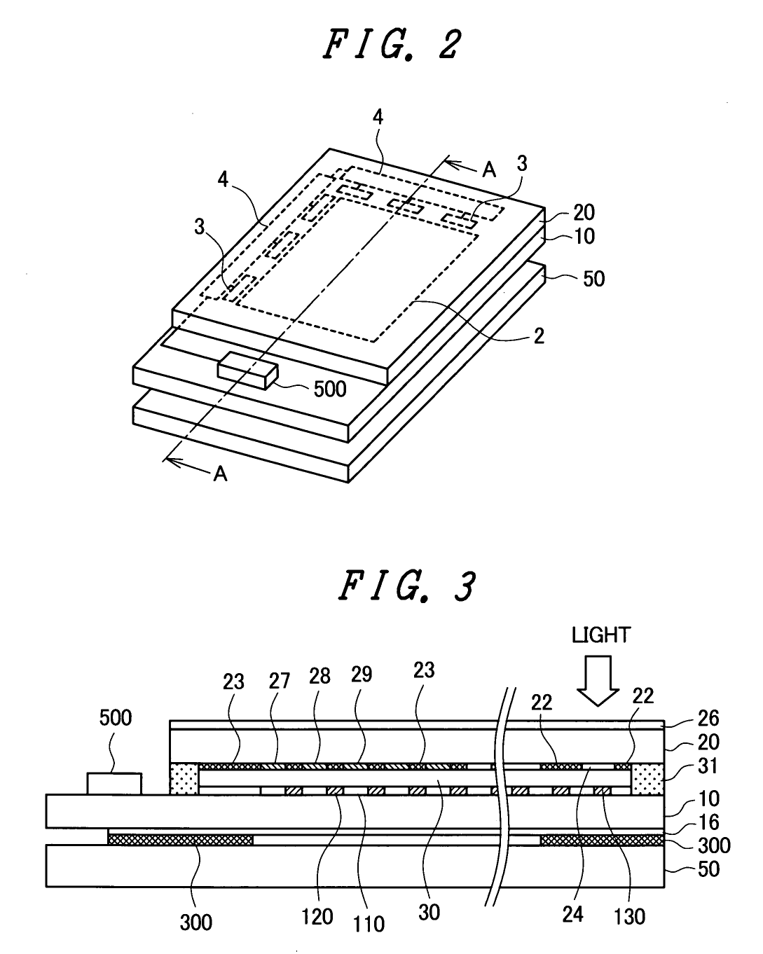

FIG. 2 is a view for explaining an example of a liquid crystal display device to which the present invention is applied. FIG. 3 is a schematic cross-sectional view of the liquid crystal display device taken along a line A-A in FIG. 2. The liquid crystal display device is constituted of a liquid crystal display panel and a backlight 50. The liquid crystal display panel is constituted of TFTs which control pixels, a TFT substrate 10 on which pixel electrodes and the like are mounted, a color filter substrate 20 on which color filters and the like are mounted, and liquid crystal 30 which is sandwiched between the TFT substrate 10 and the color filter substrate 20. The liquid crystal 30 is sealed between the TFT substrate 10 and the color filter substrate 20 using a sealing member 31.

A backlight 50 is constituted of a light source such as an LED and various kinds of optical sheets which focus light toward the liquid crystal display panel. An image is formed on the liquid crystal display panel by controlling light from the backlight 50 using the liquid crystal 30.

For controlling the light from the backlight 50 using the liquid crystal display panel, it is necessary that light which is incident on the liquid crystal display panel is polarized. A lower polarizer 16 which is adhered to a portion below the TFT substrate 10 changes the light from the backlight 50 into a polarized light. A polarization plane of the light which is polarized by the lower polarizer 16 is rotated by the liquid crystal 30 of the liquid crystal display panel and is polarized by an upper polarizer 26 which is adhered to the color filter substrate 20. The light which is controlled in such a manner is radiated from the upper polarizer 26 and is visually recognized by human eyes.

For controlling the light using the liquid crystal 30, it is necessary to apply an electric field to the liquid crystal 30. In each pixel, a degree of electric field applied to the liquid crystal 30 is determined in response to an image signal. A TFT formed on the TFT substrate 10 plays a role of a switch for transmitting the image signal to the pixel. The light which passes through the liquid crystal 30 passes through color filters such as red filters 27, green filters 28 and blue filters 29 which are formed on the color filter substrate 20 and forms a color image. A black matrix (BM23) is formed between the respective color filters for enhancing a contrast.

In FIG. 2, sensor parts 3 are formed outside the effective screen of the TFT substrate 10. Outputs from the respective sensors are transferred to an IC chip 500 which constitutes the signal processing part 5 via the P/S conversion circuit 4. The IC chip determines which sensor part generates the signal, and a function corresponding to the detected sensor part is displayed on the effective screen.

By forming the TFTs and the like using polysilicon, the photosensor part and the P/S conversion circuit 4 shown in FIG. 2 can be simultaneously formed at the time of forming a pixel-use TFTs and the like of the effective screen. Further, the signal from the sensor which passes through the P/S conversion circuit 4 is subject to information processing in a circuit which is formed in the inside of an IC chip having higher integration degree.

As shown in FIG. 3, the photosensor of the sensor part 3 is constituted of a TFT which is arranged outside the effective screen of the TFT substrate 10. The sensor-use TFT 130 is formed by steps equal to steps for forming the pixel TFT. However, the sensor-use TFT 130 has a gate and a drain thereof connected with each other to form a kind of diode. In this case, the sensor-use TFT 130 is operated as a photo diode. In the sensor part 3 shown in FIG. 2, a plurality of sensor-use TFTs 130 is formed instead of one sensor-use TFT. An interval between the sensor-use TFTs 130 is extremely small compared to an interval between window portions 24 which form a touch region and hence, a large number of sensor-use TFTs 130 can be easily formed in the region. Further, by making use of the plurality of sensor-use TFTs 130, it is possible to increase the sensitivity of the sensor.

The sensor-use TFTs 130 are formed on the TFT substrate 10 by steps equal to steps for forming the TFTs 120 in the pixel portions. In the present invention, in a usual operation state of the display device, the light is incident on the sensor-use TFTs 130. Further, when a user touches the sensor-use TFT 130 with his/her finger, the light is interrupted and a signal from the sensor-use TFT 130 is recognized.

An upper light blocking layer 22 which interrupts light is formed outside the effective screen of the color filter substrate 20, and the window 24 is formed in a portion of the color filter substrate 20 corresponding to the sensor-use TFT 130. By forming the upper light blocking layer 22 by steps equal to the steps for forming the BM 23 which is formed within the effective screen, it is possible to acquire a large light blocking effect and an advantageous effect in a cost. FIG. 3 is a view for explaining an example in which the window 24 is formed by the BM 23. Although one sensor-use TFT 130 corresponds to the window 24 in FIG. 3, as described above, there may be a case in which a plurality of sensor-use TFTs 130 corresponds to the window 24.

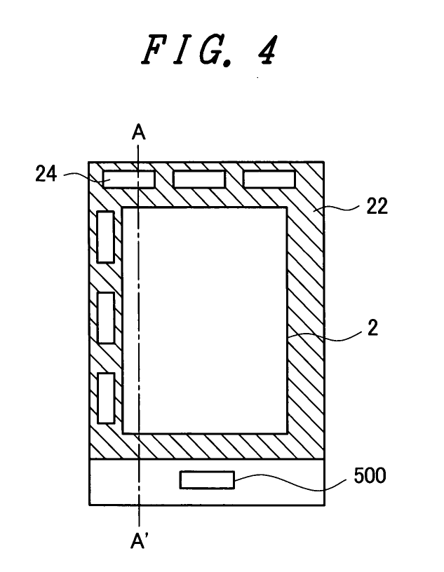

FIG. 4 is a schematic plan view of the display device shown in FIG. 1 as viewed from above. In FIG. 4, the outside of the effective screen 2 is covered with the upper light blocking layer 22, and the windows 24 for exposing the sensor-use TFTs 130 are formed in portions of the TFT substrate 10 which correspond to the photosensors 3. Although the window 24 shown in FIG. 4 corresponds to one function of the display device, the plurality of sensor-use TFTs 130 is usually formed in the window 24, and a total of signals from the plurality of sensor-use TFTs 130 is used as a detection a signal.

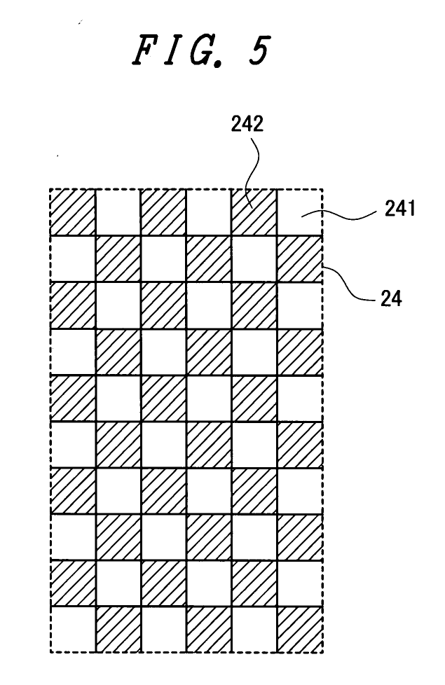

In FIG. 4, a group of sensor-use TFTs for displaying one function is formed in one window 24. However, as shown in FIG. 5, there may be a case in which a small window 241 is formed for every sensor-use TFT 130 in one window 24, and portions where the sensor-use TFTs 130 are not arranged may be covered with the upper light blocking layers 242. Such a fine pattern can be easily formed by forming the fine pattern simultaneously with the BM 23. By forming the small windows 241 corresponding to the sensor-use TFTs 130, it is possible to obtain an advantageous effect that the influence of an external light on the peripheral circuit devices can be reduced.

The light from the backlight 50 is radiated to the liquid crystal display panel. When a strong light is always radiated from the back light 50 to the sensor-use TFT 130, it is difficult to detect a change of light quantity of an external light. Accordingly, in this embodiment, as shown in FIG. 3, a lower light blocking layer 300 is arranged around the effective screen and below the lower polarizer 16.

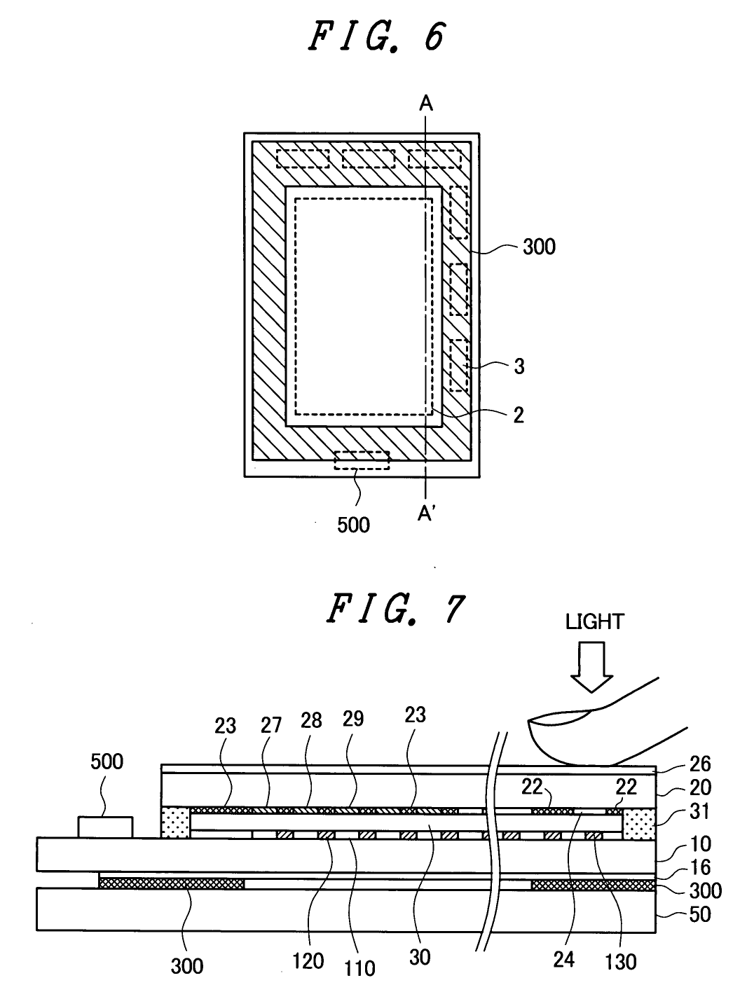

FIG. 6 is a view of the liquid crystal display panel as viewed from a back side of a TFT substrate side. A lower side of the TFT substrate 10 is covered with a lower light blocking layer 300. Since it is sufficient to prevent the light from the backlight 50 from impinging on the sensor-use TFT 130 on the lower side of the TFT substrate 10, the light blocking layer may be formed in a strip shape around the effective screen. The light blocking layer also functions as a black sealing tape for preventing the light leaked from the backlight in the upper and lower portions as well as in the left and right directions and hence, the enhancement of the operability and the performance of the display device can be expected. Further, lower light blocking layer 300 may preferably be configured to cover at least a lower portion of the sensor-use TFT 130.

FIG. 7 shows a state in which a user touches the window 24 corresponding to the sensor-use TFT portion which is formed on the TFT substrate 10 around the effective screen with his/her finger and so that an external light toward the sensor-use TFT 130 is interrupted. The light from the backlight 50 is interrupted by the lower light blocking layer 300 and hence, an photo current which is generated in the sensor-use TFT 130 is interrupted. This interruption of the photo current is converted into a voltage and the voltage is transferred to the signal processing circuit 500 via the P/S conversion circuit 4. Although only one sensor-use TFT 130 is formed in the window 24 in FIG. 7, a plurality of sensor-use TFTs 130 is usually formed in the window 24 for increasing the sensitivity of the sensor.

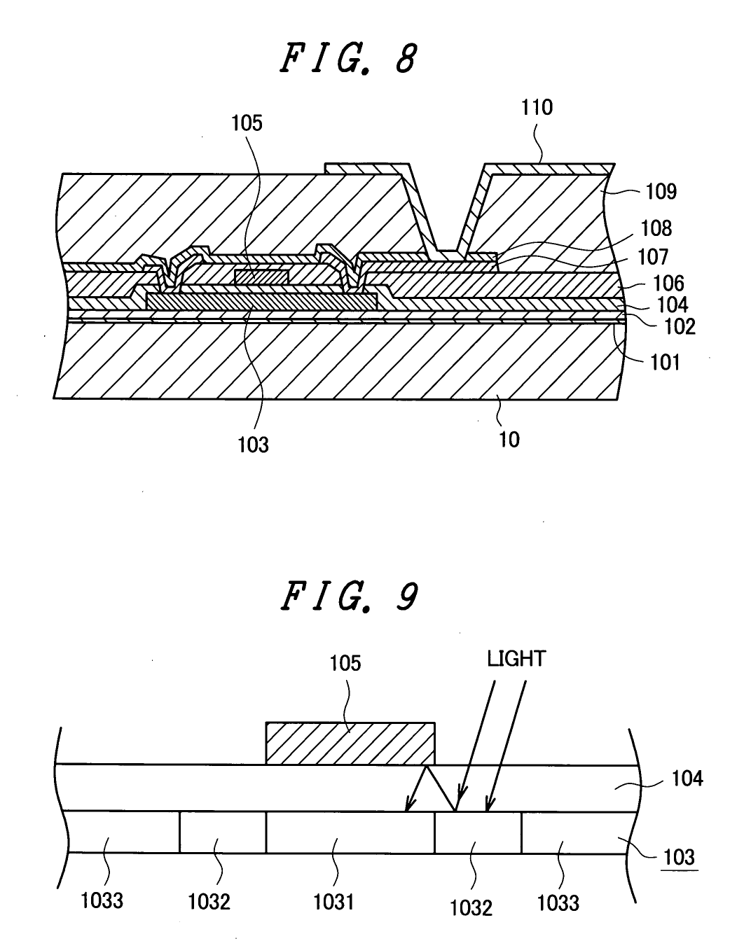

It is preferable that the sensor-use TFT 130 has the substantially same constitution as the pixel-use TFT and, at the same time, is formed simultaneously with the pixel-use TFT from a viewpoint of a yield rate, a cost and the like. FIG. 8 is a cross-sectional view of a TFT 120 in the pixel portion. As a polysilicon TFT, a so-called top-gate type TFT is used.

In FIG. 8, on the glass substrate 10, a two-layered film which is consisted of a SiN film 101 and a SiO₂ film 102 is formed as a background film. Both films are provided for preventing a semiconductor layer from being contaminated by impurities from the glass substrate 10. A poly silicon semiconductor layer 103 is formed on the SiO₂ film 102. A gate insulation film 104 which is made of SiO₂ or SiN is formed on the semiconductor layer 103. After the gate insulation film 104 is formed on the semiconductor layer 103, as a gate electrode layer 105, an MoW layer is formed on the gate insulation film 104 by sputtering, for example.

The gate electrode 105 is formed by etching using a photoresist. After etching the gate electrode 105, an ion implantation is performed prior to the removal of the photoresist so as to form an n⁺ semiconductor layer 103 by doping. By this technique, as shown in FIG. 9, three areas are formed in the semiconductor layer 103. In FIG. 9, a semiconductor layer 1031 which is arranged directly below the gate electrode and constitutes a channel portion is formed of a p-type semiconductor. A Light Doped Drain layer (LDD layer) 1032 slightly doped with n-type ions is formed on both sides of the p-type semiconductor layer 1031. This is because that the layer is doped with the ions by way of the photoresist, and a doped quantity of ions is small in semiconductor layer 1032. Other portions are sufficiently doped with ions which form such portions into an n⁺-doped layer so that other portions exhibit high conductivity. These portions constitute source/drain (S/D) regions 1033 of the TFT.

An interlayer insulation film 106 which is made of SiO₂ or SiN is formed on the gate lines including the gate electrode 105. After forming through holes for ensuring an electric contact in the interlayer insulation film 106, a stacked film formed of an Al-Si film and an MoW film or the like is formed on the interlayer insulation film 106 by sputtering and, thereafter, a source/drain wiring layer 107 and the like are formed by photolithography. Thereafter, an inorganic passivation film 108 is formed using SiN for protecting the TFT.

An organic passivation film 109 is formed on the inorganic passivation film 108 for leveling a surface of the inorganic passivation film 108. Through holes are formed in the inorganic passivation film 108 and the organic passivation film 109 for electrically connecting the source/drain wiring layers 107 and the pixel electrodes 110 and, thereafter, transparent electrodes ITO which constitute the pixel electrodes 110 are formed by sputtering. The pixel electrode 110 can be formed by patterning the transparent electrodes ITO.

The sensor-use TFT 130 basically has the same structure as the TFT 120 in the pixel portion. Here, in the sensor-use TFT 130, the pixel electrode 110 shown in FIG. 8 is unnecessary. In the sensor-use TFT 130, it is necessary to generate carriers using an external light. However, the gate electrode 105 is formed of a metal film and is opaque and hence, the external light does not directly arrive at the semiconductor layer 1031 arranged below the gate electrode 105. On the other hand, as shown in FIG. 9, the external light arrives at the LDD portions 1032 directly. The photocarrier is also generated in the LDD portions 1032 and hence, the sensor-use TFT 130 functions as the photosensor 3. Further, some of the external light also arrives at the p-type semiconductor portion 1031 which is arranged below the gate electrode 105 and constitutes the channel portion by reflections and diffractions and hence, the photocarrier is also generated in the sensor-use TFT 130 whereby it is possible to operate the sensor-use TFT 130 as the photosensor 3.

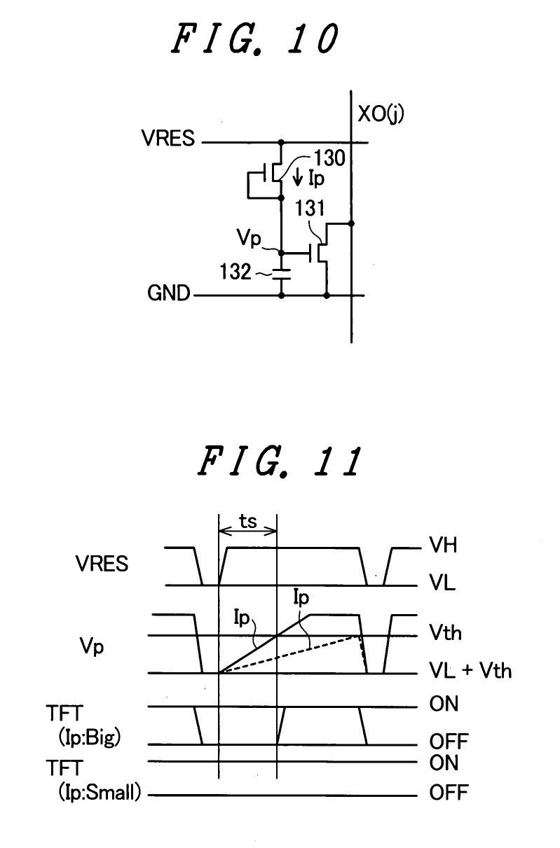

FIG. 10 to FIG. 13 are circuit diagrams for operating the sensor-use TFT 130 as the photosensor 3 of the present invention. FIG. 10 is an equivalent circuit diagram of the photosensor 3. The photosensor 3 is constituted of the sensor-use TFT 130 which is a photo diode in diode-connection, a TFT 131 which has a source thereof connected to a ground, and an integral capacitance 132. The sensor-use TFT 130 is connected between a reset line VRES and the integral capacitance 132. A drain of the source-grounded TFT 131 is connected to an output Xo(j) of the photosensor 3 and a gate of the source-grounded TFT 131 is connected to the integral capacitance 132.

FIG. 11 is a timing chart for explaining the manner of operation of the photosensor circuit shown in FIG. 10. As shown in FIG. 11, a VRES voltage is a binary signal having a high-level voltage VH and a low-level voltage VL. When the voltage of the reset line VRES assumes VL, the photo diode assumes a forward bias and hence, a voltage Vp of the integral capacitance 132 assumes VL+Vth1 (a threshold voltage of the photo diode).

Further, when the voltage of the reset line VRES is VH, the photo diode assumes a backward bias and hence, an photo current Ip corresponding to intensity of the radiated light flows in the photo diode.

The photo current Ip is integrated by the integral capacitance 132 and hence, the voltage Vp is increased with time as shown in FIG. 11. An inclination of the voltage increase in FIG. 11 is in proportion to the photo current Ip. In FIG. 11, symbol Ip-large indicates the inclination of the voltage increase when the photo current Ip is large (when the light intensity is strong) and symbol Ip-small indicates the inclination of the voltage increase when the photo current Ip is small (when the light intensity is weak).

The TFT 131 which has the gate thereof connected to the integral capacitance 132 assumes an OFF state when the voltage Vp satisfies the relationship Vp≦Vth2 and assumes an ON state when the voltage Vp satisfies the relationship Vp>Vth2. Accordingly, as indicated by symbol Ip-large in FIG. 11, when the photo current Ip is large, the state of the TFT 131 is changed from the OFF state to the ON state at a point of time at which the voltage Vp exceeds the threshold voltage Vth2, and when the photo current Ip is in the Ip-small in FIG. 11, the TFT 131 is held in the OFF state.

Here, the sensor-use TFT 130 and the TFT 131 are formed by the same TFT manufacturing steps and hence, the threshold voltage Vth1 of the sensor-use TFT 130 and the threshold voltage Vth2 of the TFT 131 are substantially equal to each other whereby it is assumed that the relationship Vth=Vth1=Vth2 is established. Here, assuming a capacitance of the integral capacitance 132 as Cp, a time difference ts from a point of time at which the photo current Ip and the voltage of the reset line VRES rise to a point of time at which the voltage Vp exceeds the threshold voltage Vth2 is expressed by a following formula.

ts=Cp×VL/Ip

From this formula, it is understood that the time difference ts is in inverse-proportion to the photo current and a coefficient of the time difference tp is determined based on the integral capacitance Cp and the low level voltages VL of the reset line VRES, and the threshold voltage Vth2 of the TFT is not included in the coefficient. In this manner, the photosensor circuit shown in FIG. 10 does not depend on the threshold voltage Vth2 of the TFT and hence, it is possible to detect the photo current (Ip) in a stable manner.

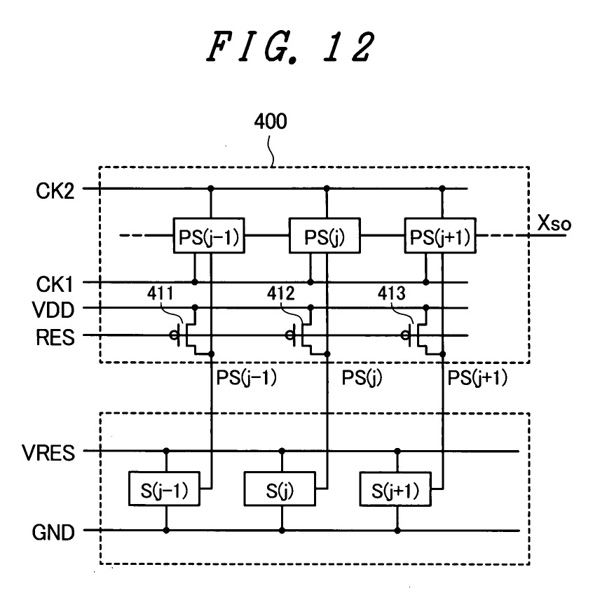

FIG. 12 is a circuit diagram showing the circuit constitution including the photosensor circuits and circuits around the photosensor circuit in this embodiment. In FIG. 12, symbol S(j) indicates the photosensor circuits shown in FIG. 10. A power source line which supplies a ground voltage GND to the photosensor circuits S(j) and the reset line VRES are connected in common outside the effective screen 2.

An output circuit 400 is constituted of parallel input/serial output circuits (hereinafter, referred to as PS circuits) PS(j) and TFTs (411 to 413) which are provided for initializing output lines X(j). The TFTs (411 to 413) are formed of a P-type thin film transistor. The initializing TFTs (411 to 413) constitute initializing circuits.

Clocks (CK1, CK2) are inputted into the PS circuit PS(j) through the X-output lines X(j). Further, a signal from a preceding stage is inputted to the PS circuit PS(j), and the PS circuit PS(j) outputs a signal to a succeeding stage.

A power source voltage VDD is applied to drains of the initializing TFTs (411 to 413) and a reset signal RES is applied to the gates of the initializing TFTs (411 to 413) and, at the same time, the sources of the initializing TFTs (411 to 413) are respectively connected to the output line X(j).

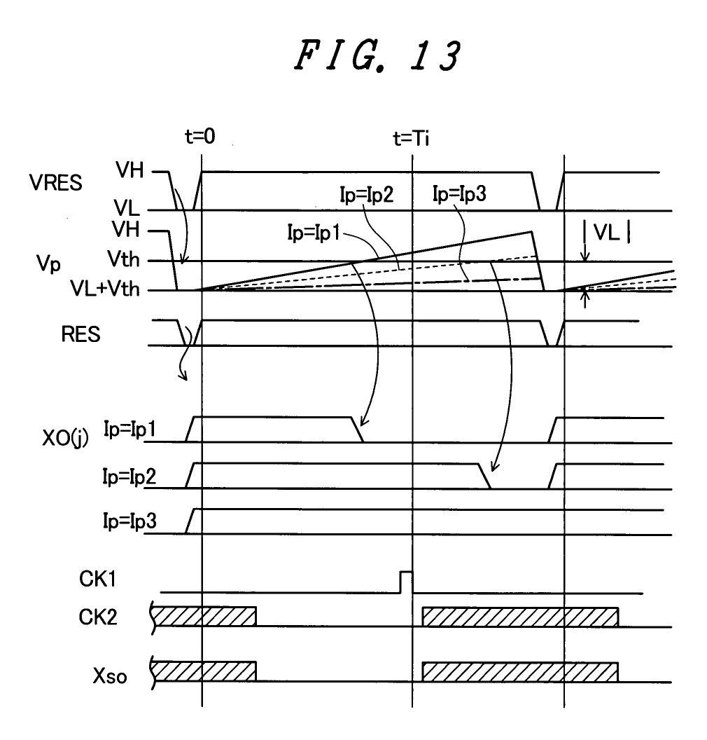

FIG. 13 is a timing chart for explaining the manner of operation of the photosensor circuits S(j) and the circuits around the photosensor circuits S(j) shown in FIG. 12. In FIG. 13, timings of applying the voltage of the reset line VRES and the voltage Vp are equal to the timings of applying the voltage of the reset line VRES and the voltage Vp in FIG. 11. The photo current Ip is provided on three conditions, that is, Ip1, Ip2 and Ip3. The reset signal RES is a signal for initializing the output line X(j), symbol Xo(j) indicates a voltage of the output line X(j), symbols (CK1, CK2) indicate control signals of the SP circuit, and symbol Xso indicates an output of the output circuit 400. A waveform of the voltage Vp is equal to a waveform of the voltage Vp shown in FIG. 11.

When the reset signal RES assumes a low level (hereinafter, referred to as an L level), the TFTs (411 to 413) assume an ON state, and the output line is initialized to the power source voltage VDD. Then, when the voltage Vp exceeds a threshold voltage of the TFT, the TFT of the photosensor circuit part assumes an ON state, and the voltage Xo(j) of the output line assumes the L level. A point of time t at which the voltage Xo(j) is changed over from the H level to the L level is changed depending on the value of the photo current Ip. The voltage Xo(j) is not changed over from the H level to the L level when the photo current Ip is Ip3.

The clock CK1 is a clock (data latch clock) which fetches data of the output line into the PS circuit. In FIG. 13, an example in which the clock CK1 is inputted into the PS circuit at timing of t=Ti is shown. The clock CK2 is a data shift clock of the PS circuit. In response to the clock CK2, the data of the PS circuit which is fetched into the PS circuit at the timing of clock CK1 is shifted, and data is outputted to the Xso.

As has been explained heretofore, by counting the outputting of the data for every fixed period, it is possible to determine a quantity of light which is incident on the photosensor 3. In the example shown in FIG. 13, when the photo current Ip is set to Ip1, that is, Ip=Ip1, the output is counted as 0, and when the photo current Ip is set to Ip2, Ip3 which is smaller than Ip1, the output is counted as 1.

In this embodiment, an external light is radiated to the photosensor 3 in a usual state. Accordingly, in this usual state, for example, the photo current Ip is set to Ip1, that is, Ip=Ip1 and hence, the output is counted as zero. However, when a user touches the substrate corresponding to the sensor part with his/her finger, the external light is interrupted and the output is changed to 1 from zero. Accordingly, it is possible to determine which function is selected.

An amount of change of light which is used for determining whether the user touches the substrate corresponding to the sensor part with his/her finger or not can be determined based on the timing Ti shown in FIG. 13. That is, when the timing Ti is prolonged, a larger change of the photo current Ip, that is, a larger change of light quantity is detected, while when the timing Ti is shortened, a smaller change of the photo current Ip, that is, a smaller change of light quantity is detected.

### Embodiment 2

The present invention acquires the advantageous effect that the sensor-use TFT 130 which is used as the photo diode has the substantially same constitution as the TFT 120 in the pixel portion and hence, the sensor-use TFT 130 and the TFT 120 in the pixel portion can be formed by the substantially same steps. However, there may be a case in which the sensor-use TFT 130 exhibits the insufficient light sensitivity compared to a case in which the sensor-use TFT 130 is manufactured as a dedicated or exclusive-use photosensor. The embodiment 2 is provided to cope with such a case and can more easily detect a quantity of change of photo current by arranging the sensor-use TFTs 130 in parallel.

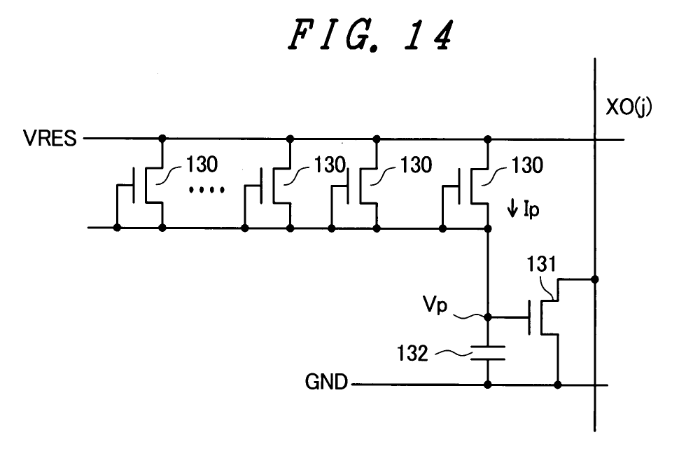

FIG. 14 shows an equivalent circuit of a photosensor 3 in the embodiment 2. The equivalent circuit shown in FIG. 14 has the same constitution as the equivalent circuit of the embodiment 1 shown in FIG. 10 except for a point that the sensor-use TFTs 130 which are used as the photo diodes are connected in parallel to each other. Due to such a constitution, even when the photo current of each sensor-use TFT 130 is small, that is, even when a change of the photo current of each sensor-use TFT 130 is small, the photo currents are added from the TFTs which are connected in parallel to each sensor-use TFT 130 and hence, it is possible to increase the sensitivity of the photosensor 3. When the total quantity of the photo current is large, the tolerance for determining whether the user touches the substrate corresponding to the photosensor 3 with his/her finger or not based on a degree of change of the light quantity can be increased.

In this embodiment, the sensor-use TFTs 130 having the substantially same constitution as the TFTs 120 in the pixel portions are used and the sensor-uses TFT 130 are manufactured using the substantially same steps as steps for manufacturing the TFTs 120 in the pixel portions. Accordingly, it is possible to enhance a manufacturing yield rate of the sensor-use TFTs 130. A detection circuit of the photo current in this embodiment is configured in the substantially same manner as the detection circuit shown in FIG. 11 to FIG. 13.

### Embodiment 3

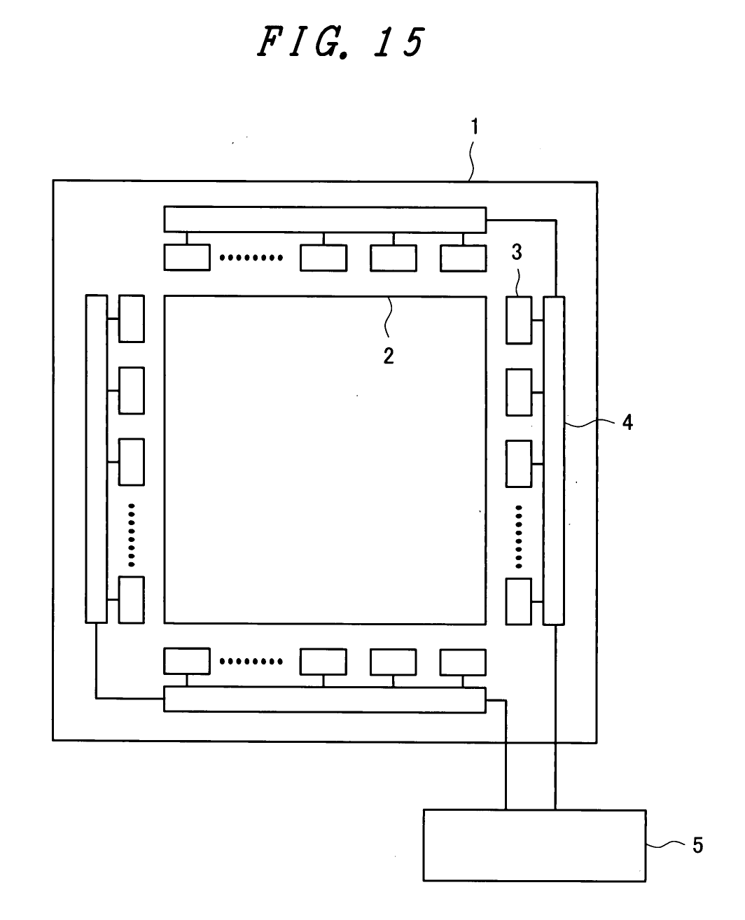

In the embodiment 1, the photosensors 3 are arranged on one side of the screen, that is, either one of left and right sides of the screen or either one of upper and lower sides of the screen. In this case, it is sufficient that one-dimensional data is used as positional date. However, as shown in FIG. 15, there also may be a case in which the sensor part is arranged on both upper and lower sides of the screen or both left and right sides of the screen. In this case, there exists a possibility that not only one-direction data but also two-direction data are demanded. The embodiment 3 is provided to satisfy such a demand.

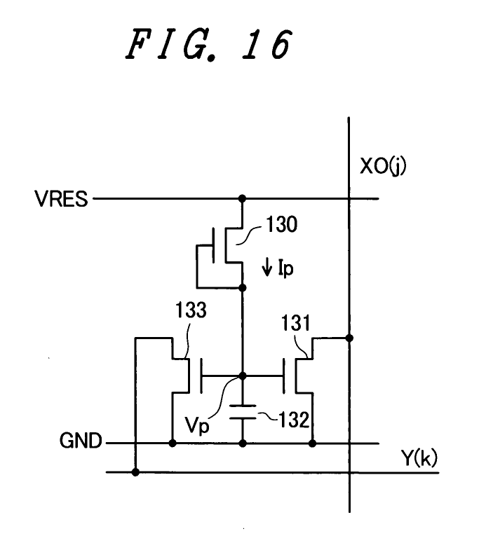

FIG. 16 shows an equivalent circuit of the photosensor 3 of the embodiment 3. The equivalent circuit of this embodiment differs from the equivalent circuit shown in FIG. 10 with respect a point that the equivalent circuit further includes a TFT 133 which gives positional information in the Y direction. Here, the “positional information in the Y direction” means positional information in the direction orthogonal to the positional information which is given in the embodiment 1. The TFT 133 has a source thereof connected to a ground, a gate thereof connected to an integral capacitance 132, and a drain thereof connected to a Y-direction output Y(k) of the photosensor 3.

The manner of operation of the TFT 133 which gives the positional information in the Y direction is equal to the manner of operation of the photosensor 3 of the embodiment 1 which gives the positional information in the X direction. Also detection circuits of an output for supplying the information in the Y direction and the manner of operation of the detection circuit can be also realized by adding one of the equivalent circuits shown in FIG. 11 to FIG. 13 to this embodiment. That is, this detection circuit is also formed on the TFT substrate 10 simultaneously with the TFT 120 in the pixel portion or the like.

According to this embodiment, it is possible to obtain the positional data in the X direction and the positional data in the Y direction based on the change of the photo current from the photo diodes formed of the same sensor-use TFT 130.

### Embodiment 4

According to the present invention, when a user touches a window portion 24 formed outside an effective screen with his/her finger so that an external light is interrupted, the photosensor 3 detects the interruption of light and inputs information. In this case, when the external light is incident from portions of the display device besides the window 24 through which the light is expected to enter, the detection sensitivity of the photosensor 3 is lowered. Most of light which is incident from parts of the display device other than the window 24 is light emitted from the backlight 50.

As shown in FIG. 3, the light from the backlight 50 is interrupted by a lower light blocking layer 300. However, the light of the backlight 50 is strong and hence, the light arrives at the photosensor 3 which is constituted of the sensor-use TFTs 130 due to the reflection of the light or the like in the inside of the TFT substrate. In the constitution of the TFT, as shown in FIG. 8, there is no light shielding layer right below a semiconductor film and hence, the semiconductor film is influenced by a light from below. Hence, even when a light shielding tape is used, there is an influence of a leaked light or a wrap-around light.

With respect to the influence of light from the backlight 50, the remoter a place where the photosensor 3 is formed form the effective screen, the photosensor 3 is less influenced by a leaked light or a wrapped-around light.

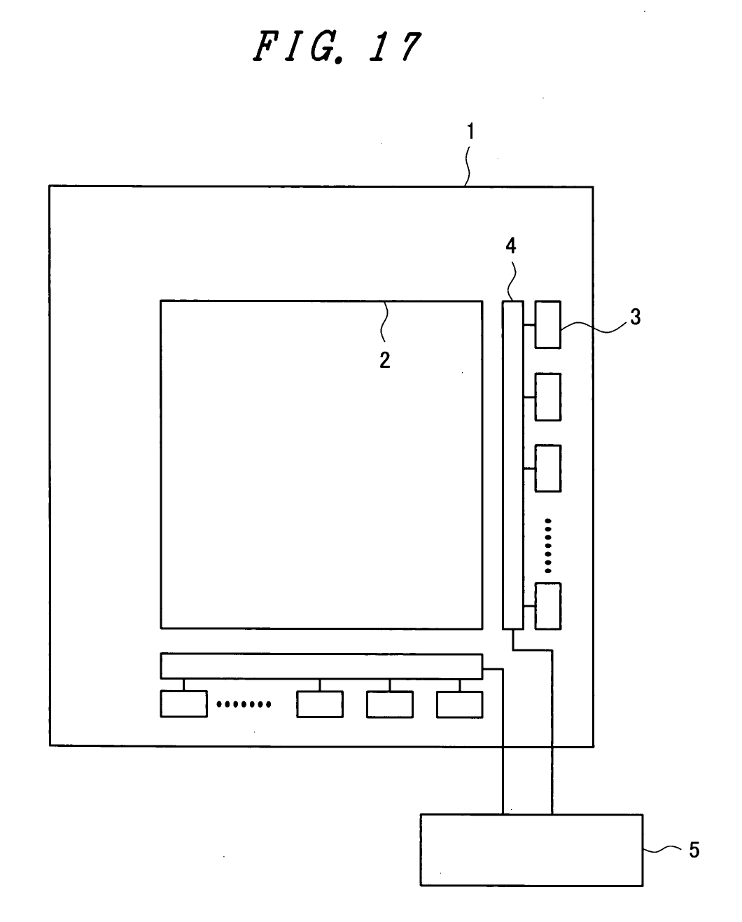

The embodiment 4 is, as shown in FIG. 17, is configured such that a PS circuit which transmits an output from the photosensor 3 to a signal processing circuit 500 and the like are arranged on a side closer to the effective screen than the photosensor 3, the influence of the backlight 50 on the photosensor 3 can be decreased.

The PS circuit or the like also has the substantially same constitution as the sensor-use TFT 130, and is incorporated in the TFT substrate 10 in the substantially same process. Accordingly, the PS circuit or the like is also influenced by the backlight 50 in the same manner as the sensor-use TFT 130. However, the PS circuit or the like is not configured to detect a change of light and hence, a change of conductivity attributed to the influence of the backlight 50 is fixed. Accordingly, it is sufficient that a threshold value of the PS circuit or the like is set by preliminarily taking the influence of the backlight into consideration. As described above, according to this embodiment, the influence of the backlight 50 on the photosensor part can be decreased and hence, the tolerance of positional detection can be increased.

### Embodiment 5

In the above-mentioned embodiments, the explanation has been made with respect to the liquid crystal display device. However, the present invention is not limited only to the liquid crystal display device, and is also applicable to an organic EL display device or the like. The organic EL display device is also conceptually configured in the same manner as the display device shown in FIG. 1. That is, a photosensor 3 for selecting functions is arranged around an effective screen portion 2.

The organic EL display device is a self-luminous device and hence, different from the liquid crystal display device, a backlight is unnecessary. Accordingly, in case of the organic EL display device, it is sufficient to take only the prevention of a stray light from an external light into consideration. The organic EL display device also uses a TFT for driving each pixel and hence, in the same manner as the liquid crystal display device, a sensor-use TFT 130 similar to the TFT of the pixel portion is manufactured as a photosensor around the effective screen.

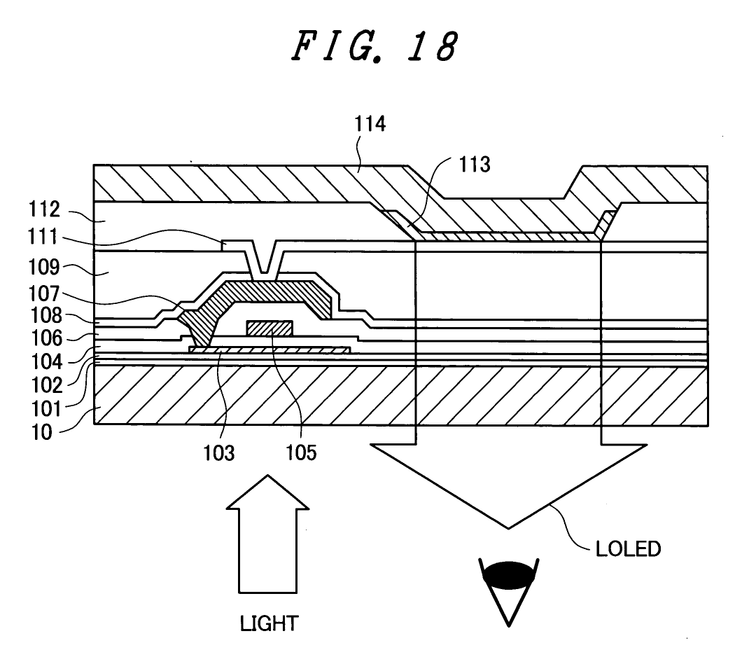

The organic EL display device is classified into a bottom-emission-type display device which radiates light from a pixel toward a TFT-substrate-10 side and a top-emission-type display device which radiates the light from the pixel toward a side opposite to a TFT substrate 10. FIG. 18 is a cross-sectional view of the bottom-emission-type organic EL display device.

In FIG. 18, in the same manner as the display device shown in FIG. 8, firstly, the TFT is formed on the TFT substrate 10. That is, on the TFT substrate 10, background films 101, 102 which adopt the two-layered structure, a semiconductor layer 103, a gate insulation film 104, a gate electrode 105, an interlayer insulation film 106, a SD line 107, an inorganic passivation film 108, and an organic passivation film 109 are formed in the same manner as explained in conjunction with FIG. 8.

In the organic EL display device, in place of the pixel electrode 110 shown in FIG. 8, a lower electrode 111 is formed. However, the lower electrode 111 is made of ITO in the same manner as the pixel electrode 110 shown in FIG. 8. In the organic EL display device, a bank 112 is provided for separating the pixels from each other and, thereafter, an organic EL film 113 is formed by vapor deposition. The organic EL film 113 is usually constituted of thin organic films stacked in five to six layers. An upper electrode 114 made of Al or Al alloy is formed on the organic EL film 113.

When a voltage is applied between the upper electrode 114 and the lower electrode 111, the organic EL layer 113 emits light and this light advances toward the TFT-substrate-10 side. Light which is radiated toward the side opposite to the TFT substrate 10 is reflected on the upper electrode 114 which is made of metal and advances toward the TFT-substare-10 side. A user recognizes an image by observing the light which the organic EL layer 113 emits from the TFT-substrate-10 side.

The sensor-use TFT 130 formed around the effective screen has the substantially equal constitution as the TFT in the pixel portion shown in FIG. 18 and, at the same time, is formed using the substantially same process. The constitution which makes the display device of this embodiment differ from the liquid crystal display device of the embodiment 1 or the like lies in that the external light impinges on a channel portion of the TFT without being interrupted by a gate electrode. That is, according to this embodiment, a change of photo current attributed to a change of light which is brought about when a human finger touches a window 24 of the photosensor part formed around the effective screen can be largely increased compared to other embodiments and the like. Accordingly, the tolerance of the detection can be increased by an amount corresponding to the increase of the change of the photo current.

The above-mentioned embodiments have been explained with respect to the case in which the semiconductor layer is made of polysilicon. However, depending on the display device, the semiconductor layer may be made of a-Si. Polysilicon exhibits large carrier mobility and hence, the PS circuit and the like can be relatively easily incorporated into a portion around the effective screen. However, an output of the photosensor 3 used in the present invention does not require a high-speed operation and hence, the mobility of a-Si may have the sufficient tolerance.

What is claimed is:

1. A display device which includes a substrate on which pixels are mounted in a matrix array within an effective screen thereof, and in which an image signal applied to each pixel is controlled by a thin film transistor which corresponds to each pixel, wherein
a photosensor is arranged on the substrate outside the effective screen, the photosensor generates a signal by interrupting an external light, and the signal from the photosensor allows the display device to perform a specific function.

2. A display device according to claim 1, wherein a light blocking layer which interrupts the external light is formed on the substrate outside the effective screen, and the light blocking layer is not formed on a portion of the substrate which corresponds to the photosensor.

3. A display device according to claim 1, wherein the photosensor is constituted of a sensor-use thin film transistor which is formed by steps equal to the steps for forming the thin film transistor which corresponds to each pixel.

4. A display device according to claim 3, wherein a gate of the sensor-use thin film transistor adopts the diode constitution in which the gate is connected to a drain or a source of the sensor-use thin film transistor.

5. A display device according to claim 1, wherein the signal from the photosensor is transmitted to a signal processing circuit via a circuit which is mounted on the same substrate on which the thin film transistor corresponding to each pixel is formed and transfers the signal.

6. A display device according to claim 5, wherein the circuit which transfers the signal includes a parallel/serial conversion circuit.

7. A display device according to claim 5, wherein the circuit which transfers a signal is formed on a side closer to the effective screen side than the photosensor.

8. A display device according to claim 3, wherein the thin film transistor corresponding to each pixel is made of polysilicon.

9. A display device according to claim 1, wherein a light blocking layer is formed on a portion of a back side of the substrate on which the photosensor is formed in a state that the portion corresponds to a portion of the substrate where the photosensor is arranged.

10. A display device according to claim 1, wherein a plurality of photosensors is formed outside the effective screen, and signals form the plurality of photosensors allow the display device to perform the same function.

11. A display device according to claim 1, wherein a light blocking layer for interrupting an external light is formed outside the effective screen, a window portion in which the light blocking layer is not formed is formed on a portion of the substrate which corresponds to the photosensor, and a plurality of photosensors is formed in the portion of the substrate which corresponds to the window portion.

12. A liquid crystal display device comprising:
a liquid crystal display panel which includes a TFT substrate on which pixel electrodes and thin film transistors each of which controls a signal voltage applied to the pixel electrodes are formed within an effective screen thereof, a color filter substrate on which color filters and a black matrix are formed within an effective screen thereof, and liquid crystal which is sandwiched by the TFT substrate and the color filter substrate, and forms an image; and
a backlight, wherein
the photosensor is formed outside the effective screen of the TFT substrate, the photosensor generates a signal by interrupting an external light, and the signal from the photosensor allows the display device to perform a specific function.

13. A liquid crystal display device according to claim 12, wherein a light blocking film which interrupts the external light is formed outside the effective screen of the color filter substrate, and the light blocking film is not formed on a portion of the color filter substrate which corresponds to the photosensor.

14. A liquid crystal display device according to claim 12, wherein the light blocking film is made of the same material as the black matrix.

15. A liquid crystal display device according to claim 12, wherein the photosensor is constituted of a sensor-use thin film transistor which is formed by steps equal to steps for forming the thin film transistor which controls the signal voltage applied to the pixel electrodes.

16. A liquid crystal display device according to claim 15, wherein a gate of the sensor-use thin film transistor adopts the diode constitution in which the gate is connected to a drain or a source of the sensor-use thin film transistor.

17. A liquid crystal display device according to claim 12, wherein a light blocking layer is formed between the TFT substrate on which the photosensor is formed and the backlight.

18. An organic EL display device which includes a substrate on which organic EL layers which constitute pixels within an effective screen are formed in a matrix array, and forms an image by applying a signal voltage to the organic EL layers, wherein
the signal voltage applied to the organic EL layer is controlled by a thin film transistor, a photosensor is arranged on the substrate outside the effective screen, the photosensor generates a signal by interrupting an external light, and the signal from the photosensor allows the display deice to perform a specific function.

19. An organic EL display device according to claim 18, wherein the photosensor includes a sensor-use thin film transistor which is formed by steps equal to the steps for forming the thin film transistor which controls the signal voltage applied to the organic EL layer.

20. An organic EL display device according to claim 18, wherein the organic EL display device is of a bottom emission type.
